(19) United States
(12) Patent Application Publication
(10) Pub. No.: US 2022/0192118 A1
(43) Pub. Date: Jun. 23, 2022

(54) PLANT CULTIVATION APPARATUS

(71) Applicant: LG Electronics Inc., Seoul (KR)

(72) Inventor: Imsung YOO, Seoul (KR)

(21) Appl. No.: 17/560,973

(22) Filed: Dec. 23, 2021

(30) Foreign Application Priority Data
Dec. 23, 2020 (KR) 10-2020-0181879

(51) Int. Cl. A01G 31/06

(52) U.S. Cl. CPC A01G 31/06; A01G 2031/006

(57) ABSTRACT

A plant cultivation apparatus includes a cabinet configured to accommodate a cultivator that is configured to accommodate at least a portion of a plant, a storage configured to store nutrient liquid to be supplied to the cultivator, a supply path connected to the storage and configured to supply the nutrient liquid from the storage to the cultivator, and a nutrient liquid circulator that includes a first member configured to increase a pH of the nutrient liquid and a second member configured to decrease the pH of the nutrient liquid. The nutrient liquid circulator is configured to discharge the nutrient liquid from the storage and to circulate the nutrient liquid to the storage through at least one of the first member or the second member.

### CROSS-REFERENCE TO RELATED APPLICATIONS

This application claims the benefit of Korean Patent Application No. 10-2020-0181879, filed on Dec. 23, 2020, which is hereby incorporated by reference as when fully set forth herein.

### TECHNICAL FIELD

The present disclosure relates to a plant cultivation apparatus and a method for controlling the same, and more particularly, relates to a plant cultivation apparatus for cultivating a plant in a cultivator disposed therein, and a method for controlling the same.

### BACKGROUND

A plant cultivation apparatus refers to an apparatus that can perform cultivation of a plant by supplying and controlling light energy, moisture, soil, temperature, etc. for plant growth. For example, the plant cultivation apparatus may include a cultivation space which creates an environment suitable for plant growth. The plant may grow in the cultivation space.

In some examples, the plant cultivation apparatus may include a component for supplying moisture and nutrients for plant growth. In some cases, a component for supplying light energy to the plant may also be included in the apparatus. Accordingly, the plant may be cultivated in the plant cultivation apparatus while light from the sun is not applied thereto.

In some cases, the plant cultivation apparatus may include a nutrient liquid supply for supplying the plant with a nutrient liquid including moisture and nutrients for plant growth. The nutrient liquid supply may include storage for storing the nutrient liquid, and a supply part connected to the storage part to supply the nutrient liquid in the storage part to the cultivator receiving at least a portion of the plant.

In some examples, the nutrient liquid from the nutrient liquid supply may not be consumed once and wasted, but may be used repeatedly at least partially while being stored in the storage part. In some cases, a pH of the nutrient liquid stored in the storage part may change, or foreign substances may be produced therein.

When the pH of the nutrient liquid stored in the storage part is equal to an inappropriate value at which the liquid is to be fed to the plant, or when bacteria or foreign substances are excessively present in the nutrient liquid, the growth of the plant may be adversely affected.

In some cases, an apparatus may sterilize a nutrient liquid using ultraviolet light. In some cases, an apparatus for purification of a nutrient liquid may perform sterilization of a nutrient liquid using ultraviolet light.

In some cases, a nutrient liquid management method using ultraviolet rays may not have an effect other than the sterilization effect. In some cases, the effect may vary depending on turbidity of the nutrient liquid or a contamination amount of an ultraviolet emitter.

Therefore, it is important to effectively manage the pH of the nutrient liquid to be supplied to the plant and to effectively remove impurities and bacteria of the nutrient liquid to provide the plant with high quality nutrient liquid.

### SUMMARY

The present disclosure describes a plant cultivation apparatus and a method for controlling the plant cultivation apparatus in which the nutrient liquid to be fed to the plant is effectively managed so that the plant can grow effectively.

The present disclosure further describes a plant cultivation apparatus that can supply high-quality nutrient liquid to a plant while effectively managing the pH of the nutrient liquid to be fed to the plant, and a method for controlling the same.

The present disclosure further describes a plant cultivation apparatus that can supply high-quality nutrient liquid to a plant while effectively removing harmful bacteria contained in the nutrient liquid to be fed to the plant and a method for controlling the same.

The present disclosure further describes a plant cultivation apparatus that can supply high-quality nutrient liquid to a plant while effectively removing impurities or foreign substances contained in the nutrient liquid to be fed to the plant and a method for controlling the same.

The present disclosure further describes a plant cultivation apparatus that can effectively provide high-quality nutrient liquid to a plant while simultaneously achieving removal of bacteria and foreign substances contained in the liquid along with the pH management of the nutrient liquid to be fed to the plant, and a method for controlling the same.

According to one aspect of the subject matter described in this application, a plant cultivation apparatus includes a cabinet configured to accommodate a cultivator that is configured to accommodate at least a portion of a plant, a storage configured to store nutrient liquid to be supplied to the cultivator, a supply path connected to the storage and configured to supply the nutrient liquid from the storage to the cultivator, and a nutrient liquid circulator that includes a first member configured to increase a pH of the nutrient liquid and a second member configured to decrease the pH of the nutrient liquid. The nutrient liquid circulator is configured to discharge the nutrient liquid from the storage and to circulate the nutrient liquid to the storage through at least one of the first member or the second member.

Implementations according to this aspect can include one or more of the following features. For example, the nutrient liquid circulator can further include a storage channel that extends from the storage, a valve disposed at the storage channel, a first connective channel that connects the valve to the first member, and a second connective channel that connects the valve to the second member, where the plant cultivation apparatus can further include a controller configured to control the valve to supply the nutrient liquid discharged from the storage channel to one of the first connective channel or the second connective channel.

In some implementations, the first member can include a basic substance having a pH range greater than a neutral pH, and the second member can include an acidic substance having a pH range less than the neutral pH.

In some implementations, the plant cultivation apparatus can further include a pH sensor configured to measure the pH of the nutrient liquid stored in the storage and a controller configured to control the nutrient liquid circulator to perform a pH management mode in which the nutrient liquid circulator controls a path of the nutrient liquid to the first member or the second member based on a measurement value of the pH sensor. In some examples, the nutrient liquid circulator can be configured to, based on the measurement value of the pH sensor being less than or equal to a reference pH range, circulate the nutrient liquid to the storage through the first member, and based on the measurement value of the pH sensor being greater than the reference pH range, circulate the nutrient liquid to the storage through the second member.

In some implementations, the controller can be configured to control the nutrient liquid circulator to perform the pH management mode such that the measurement value of the pH sensor becomes within a threshold pH range that is preset within the reference pH range. In some examples, the controller can be configured to transmit a check signal to a user for checking the nutrient liquid circulator based on the measurement value of the pH sensor remaining outside the threshold pH range for an execution duration of the pH management mode that is greater than or equal to a preset duration.

In some implementations, the controller can be configured to control the nutrient liquid circulator to limit a total operation duration of each of the first member and the second member within a preset operation duration. In some implementations, the plant cultivation apparatus can further include a nutrient sensor configured to measure a remaining amount of the nutrient liquid stored in the storage, where the controller is configured to change the preset operation duration based on a measurement value of the nutrient sensor.

In some implementations, the first member can be configured to remove impurities from the nutrient liquid to thereby reduce a turbidity of the nutrient liquid, and the first member can be configured to increase the pH of the nutrient liquid while removing the impurities from the nutrient liquid. In some examples, the first member can include activated carbon, where the first member can be configured to, based on the nutrient liquid passing through the activated carbon, remove the impurities from the nutrient liquid and increase the pH of the nutrient liquid. In some implementations, the second member can be configured to apply an electrical current to the nutrient liquid discharged from the storage to thereby sterilize the nutrient liquid and reduce the pH of the nutrient liquid.

In some implementations, the plant cultivation apparatus can further include a turbidity sensor configured to measure the turbidity of the nutrient liquid stored in the storage, and a controller configured to, based on a measurement value of the turbidity sensor being greater than or equal to a reference turbidity, control the nutrient liquid circulator to perform a turbidity management mode to thereby circulate the nutrient liquid through the first member. In some examples, the controller can be configured to transmit a check signal to a user for checking the nutrient liquid based on the measurement value of the turbidity sensor remaining greater than or equal to the reference turbidity for an execution duration of the turbidity management mode that is greater than or equal to a preset duration.

In some implementations, the plant cultivation apparatus can include a pH sensor configured to measure the pH of the nutrient liquid stored in the storage, where the controller is configured to control the nutrient liquid circulator to perform the turbidity management mode based on the measurement value of the turbidity sensor being greater than or equal to the reference turbidity and a measurement value of the pH sensor being lower than or equal to a turbidity management pH value. In some examples, the controller can be configured to, based on the measurement value of the turbidity sensor being greater than or equal to the reference turbidity and the measurement value of the pH sensor exceeding the turbidity management pH value, control the nutrient liquid circulator to perform a pH preparation mode to thereby circulate the nutrient liquid to the storage through the second member. The controller can be configured to perform the turbidity management mode based on the measurement value of the pH sensor becoming less than or equal to the turbidity management pH value during performance of the pH preparation mode.

In some implementations, the controller can be configured to, based on the measurement value of the pH sensor being outside a reference pH range, control the nutrient liquid circulator to perform a pH management mode such that the measurement value of the pH sensor becomes within a threshold pH range that is preset within the reference pH range, where the turbidity management pH value is greater than or equal to a lower limit of the threshold pH range.

According to another aspect, a method controls the plant cultivation apparatus described above. The method includes measuring a pH of the nutrient liquid stored in the storage by a pH sensor, determining whether a measurement value of the pH sensor is within a reference pH range, and based on the measurement value of the pH sensor being outside the reference pH range, controlling the nutrient liquid circulator to perform a pH management mode to thereby adjust the pH of the nutrient liquid stored in the storage.

Implementations according to this aspect can include one or more of the following features. For example, controlling the nutrient liquid circulator can include, based on the measurement value of the pH sensor being less than or equal to the reference pH range, circulating the nutrient liquid to the storage through the first member, and based on the measurement value of the pH sensor being greater than the reference pH range, circulating the nutrient liquid to the storage through the second member.

In some examples, the method can further include performing the pH management mode until the measurement value of the pH sensor comes in a threshold pH range that is preset within the reference pH range.

In some implementations, an electrolysis module can reduce the pH of the nutrient liquid by generating and supplying hypochlorous acid to the nutrient liquid flowing through a space between electrodes using DC power. An activated carbon module can remove physical contamination of the nutrient liquid, detoxify the plant and increase the pH of the nutrient liquid.

In some implementations, a turbidity sensor can detect a level of physical contamination of the nutrient liquid due to plant roots or floating matter. The pH sensor can be provided to measure the pH of the nutrient liquid. When the pH of the nutrient liquid is out of a reference pH range, plant growth can be impaired.

In some implementations, a nutrient liquid tank can be connected to the sterilization module and the activated carbon module. Thus, sterilization of the nutrient liquid, filtration, and the pH of the nutrient liquid can be adjusted.

In some implementations, the apparatus can include storage in which the nutrient liquid is stored, and a sterilization module connected to the storage part. For example, the sterilization module can be an electrolysis module. The activated carbon module connected to the storage part can be included in the apparatus. The electrolysis module and the activated carbon module can be connected to the storage part via a pump and a valve.

In some implementations, the storage part can identify a current state of the nutrient liquid, and can include a pH sensor, a turbidity sensor, etc. for controlling an operation of the sterilization module and the activated carbon module. Depending on whether the sterilization module or the activated carbon module is activated, the pump and the valve can be activated or deactivated in an association manner therewith.

In some implementations, the sterilization module can produce hypochlorous acid. The activated carbon module can be provided in a form in which a cartridge containing activated carbon can be exchanged. When the pH of the nutrient liquid is high, or when off flavor is produced, the nutrient liquid can be circulated to the sterilization module in which the sterilization can proceed. When the pH of the nutrient liquid is low or impurities are present in the nutrient liquid, the nutrient liquid can be circulated to the activated carbon module.

### BRIEF DESCRIPTION OF THE DRAWINGS

FIG. 1 is a diagram showing an outer appearance of an example of a plant cultivation apparatus.

FIG. 2 is a diagram showing an inside of the plant cultivation apparatus and an example of a door that is open.

FIG. 3 is a diagram showing a partially cut away state of the plant cultivation apparatus in the open state.

FIG. 4 is a diagram showing a cross-section of an inside of the plant cultivation apparatus.

FIG. 5 is a diagram showing an example of a cultivator in the plant cultivation apparatus.

FIG. 6 is a diagram showing an internal configuration of the plant cultivation apparatus.

FIG. 7 is a conceptual diagram showing an example of a nutrient liquid supply and a nutrient liquid circulator in the plant cultivation apparatus.

FIG. 8 is a diagram showing an example of pH ranges in nutrient liquid in the plant cultivation apparatus.

FIG. 9 is a flowchart showing an example of a pH management operation of an example of a control method of the plant cultivation apparatus.

FIG. 10 is a flowchart showing an example of a turbidity management operation of the control method.

FIG. 11 is a diagram showing an example of a flowchart in which the pH management operation and the turbidity management operation are performed together in the control method.

### DETAILED DESCRIPTION

Hereinafter, one or more implementations of the present disclosure will be described in detail with reference to the accompanying drawings. The same reference numbers can be allocated to the same or similar components. Redundant descriptions thereof will be omitted.

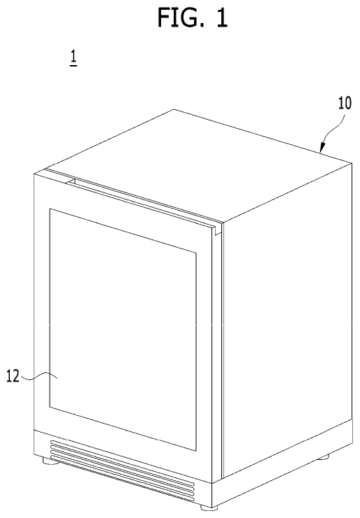

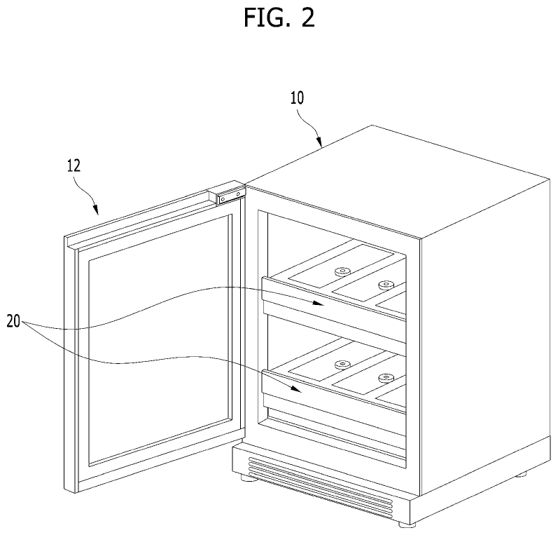

FIG. 1 is a diagram showing an outer appearance of an example of a plant cultivation apparatus 1. FIG. 2 is a diagram showing an example state where the plant cultivation apparatus is opened such that an inside thereof is exposed outwardly. That is, FIG. 2 shows a state in which a door 12 of a cabinet 10 is opened in the plant cultivation apparatus 1 of FIG. 1 to expose an inside of the cabinet 10 outwardly.

In some implementations, referring to FIGS. 1 and 2, the plant cultivation apparatus 1 can include the cabinet 10 that defines the outer appearance of the plant cultivation apparatus 1. A cultivation space 15 for plant growth can be defined therein.

The cabinet 10 can be provided in a variety of shapes. FIGS. 1 and 2 show the cabinet 10 having a rectangular cross-section, for instance. The cabinet 10 can have one open face so that the inside thereof is exposed outwardly through the open face. FIGS. 1 and 2 show that the open face of cabinet 10 is a front face. A user can access the cultivation space 15 inside the cabinet 10 through the open face or the opening of the cabinet 10, and thus can access a cultivator 30 placed in the cultivation space 15.

In some implementations, the plant cultivation apparatus 1 can further include the door 12. The door 12 can be pivotably disposed at the cabinet 10 to selectively shield the open face or the opening of the cabinet 10. The user can access the cultivation space 15 inside cabinet 10 while opening the door 12.

Referring to FIG. 2, inside the cabinet 10, a bed 20 on which the cultivator 30 is seated can be provided. A receiving portion on which the cultivator 30 can be seated can be formed in the bed 20. The user can place the cultivator 30 onto the receiving portion and cultivate the plant therein.

The bed 20 can include a plurality of beds. In this case, the plurality of beds 20 can be arranged to be spaced apart from each other so that the user can easily access the receiving portion. In FIG. 2, a plurality of plate-shaped beds 20 are shown to be arranged to be spaced apart from each other in a vertical direction.

However, the present disclosure is not necessarily limited thereto. A shape or an arrangement direction of the beds 20 can vary in other implementations.

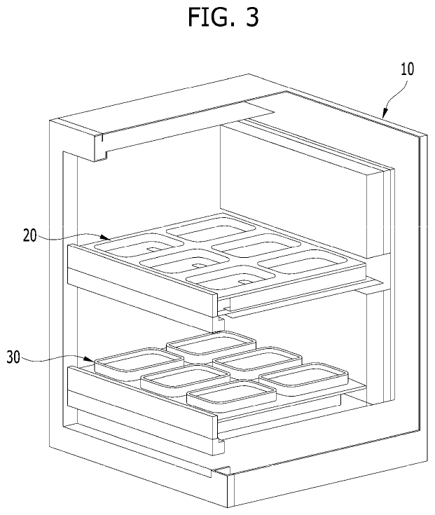

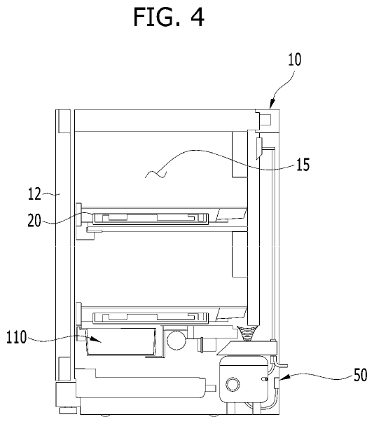

FIG. 3 is a diagram showing an example of a partially cut away state of the plant cultivation apparatus in the open state. FIG. 4 is a diagram showing a cross-section of an example of an inside of the plant cultivation apparatus. That is, FIG. 3 shows the cultivation space 15 while a portion of the cabinet 10 is cut away. FIG. 4 shows a cross-section of the partially cut away cabinet 10.

In some implementations, a plurality of receiving portions can be defined in each of the beds 20, and the number thereof can vary in other implementations. For instance, FIG. 3 shows six receiving portions that are defined in a single bed 20. In some examples, as shown in FIG. 3, two beds 20 are provided for example, and the two beds 20 can include a lower bed 20 and an upper bed 20. The cultivator 30 can be seated on the receiving portion of the lower bed, while the cultivator 30 is removed from the receiving portion of the upper bed.

Referring to the upper bed 20 of FIG. 3, the receiving portion can be defined in a recessed form in one face of the bed 20. The receiving portion has a cross-sectional shape corresponding to a cross-sectional shape of the cultivator 30 so that the cultivator 30 can be stably fitted into the receiving portion.

Referring to the lower bed 20 of FIG. 3, the cultivator 30 can be seated on the bed 20. That is, the bed 20 can include the receiving portion defined in a form of a depression or a protrusion in or on a top face of the bed. The cultivator 30 can be placed on or in the receiving portion.

The user can open the door 12 to access the cultivation space 15 inside the cabinet 10. The cultivator 30 can be formed integrally with the bed 20 or separately formed therewith such that the user can place the cultivator on the receiving portion.

Referring to FIG. 4, a machine room 50 can be disposed inside the cabinet 10. The machine room 50 can be provided integrally with the cultivation space 15 or can be provided separately from the cultivation space 15.

FIG. 4 shows that the machine room 50 separated from the cultivation space 15 is disposed in a bottom portion of the inside of the cabinet 10.

The machine room 50 can receive therein various components. For example, at least a portion of an air circulator for circulating air inside the cabinet 10 or for inflowing outside-air into the cabinet 10 can be located in the machine room 50. At least a portion of the nutrient liquid supply 100 for supplying the nutrient liquid to the cultivator 30 can be placed in the machine room 50.

In some examples, inside the cabinet 10, a light irradiator can provide light to the cultivator 30. The light irradiator can include a light emitter that generates light. The light emitter can be placed on a top face of the cabinet 10 or above the bed 20.

In some implementations, as show in FIG. 4, the nutrient liquid storage 110 of the nutrient liquid supply 100 can be configured to store the nutrient liquid, and a pump for causing flow of the nutrient liquid can be disposed inside the machine room 50. The plurality of bed 20 can be disposed above the machine room 50 to form a plurality of layers.

At least a portion of the air circulator and at least a portion of the nutrient liquid supply 100 can be disposed in rear of the bed 20 and inside the cabinet 10. For example, a circulation fan for circulating the air can be disposed in a rear portion of the cabinet 10. A nutrient liquid supply 120 to supply the nutrient liquid to the cultivator 30 can be disposed in a rear portion of the cabinet 10.

A rear space can be defined in a rear portion of the cabinet 10, and can be separated from the cultivation space 15 via a dividing wall. At least a portion of the air circulation unit and at least a portion of the nutrient liquid supply 100 can be disposed in the rear space.

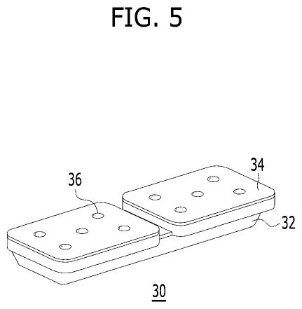

FIG. 5 shows an appearance of the cultivator 30 seated on the receiving portion. The cultivator 30 can be provided in a form in which at least a portion of the plant is received therein, and can be provided integrally with the bed 20 or separately therefrom to be seated on the bed 20 by the user.

The cultivator 30 can include a cultivation vessel 32 in which a space is defined and a cultivator cover 34 combined with the cultivation vessel 32. The cultivation vessel 32 can have an open top face or an opening defined in a top face thereof. The cultivator cover 34 can be constructed to cover the open top face of the cultivation vessel 32 or an opening defined in the top face thereof.

FIG. 5 is a diagram showing an example of the cultivator in the plant cultivation apparatus. That is, FIG. 5 shows a state in which the top face of the cultivation vessel 32 is opened, and the cultivator cover 34 is coupled to the cultivation vessel 32 to shield the open top face of the cultivation vessel 32.

At least a portion of the plant received in the cultivator 30. For example, seeds of a plant or roots of a plant can be received inside the cultivator 30. The cultivator 30 can receive a cultivation medium in which plant seeds are received.

The cultivation medium can be prepared so as to receive therein the seeds of the plant or the roots of the plant, and can be contained inside the cultivation vessel 32. The cultivation medium can contain nutrients for plant growth. Plants can grow upon receiving the nutrients from the cultivation medium.

The cultivator cover 34 can have a cover hole 36 defined in a position corresponding to the plant or the cultivation medium inside the cultivation vessel 32. The plant can grow in the inside of the cultivation vessel 32 and can extend outside the cultivator 30 through the cover hole 36, that is, can extend into the cultivation space 15.

The cultivator 30 can be constructed such that air or nutrient liquid can be fed to the plant through the cover hole 36. The cultivator 30 can be constructed such that the nutrient liquid of the nutrient liquid supply 100 can be supplied to the inside of the cultivation vessel 32 and then can be fed to the plant. The cultivator 30 can have a nutrient storage in which nutrients to be supplied to the plant are stored, in a separate manner from the cultivation medium.

A plurality of plants or cultivation medium can be disposed inside the cultivator 30. In some examples, as shown in FIG. 5, five cover holes 36 can be defined in each cultivator cover 34, and at least a portion of the plant is located in the cultivation vessel 32 disposed equal to or lower than the cover holes 36.

FIG. 5 shows a state in which a pair of cultivators 30 are provided integrally with each other. However, the present invention is not limited thereto. The cultivators 30 can be separated from each other, or the two or more cultivators 30 can be provided integrally with each other.

An indicator can be disposed on one face of the cultivation cover 34 of the cultivator 30. The indicator can be constructed to cover one face of the cultivator cover 34. A type of the plant received into the cultivator 30 can be displayed on the indicator.

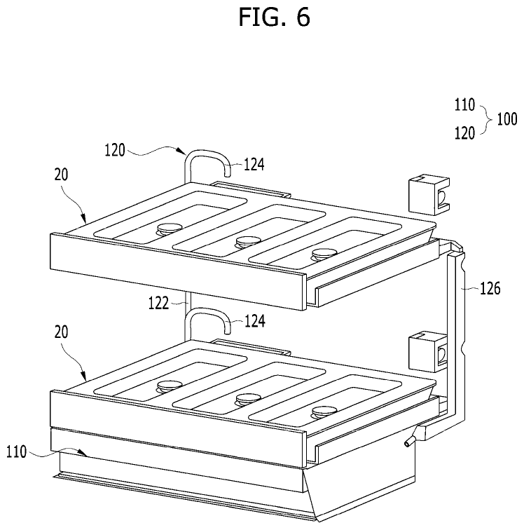

FIG. 6 is a diagram showing an internal configuration of a plant cultivation apparatus. For example, FIG. 6 shows the bed 20 and the nutrient liquid supply 100 of the plant cultivation apparatus 1.

Referring to FIG. 6, the nutrient liquid supply 100 can include the nutrient liquid storage 110 where the nutrient liquid is stored and the nutrient liquid supply 120 connected to the nutrient liquid storage 110 to supply the nutrient liquid from the nutrient liquid storage 110 to the cultivator 30.

The nutrient liquid is stored in an inner space of the nutrient liquid storage 110. Pre-prepared nutrient liquid can be stored therein, or water and nutrients can be mixed with each other inside the nutrient liquid storage 110 to prepare the nutrient liquid.

The nutrient liquid storage 110 can be exposed to the outside through the open face of the cabinet 10 such that the user can access the storage part. Alternatively, in addition to the open face of the cabinet 10, a separate opening can be defined such that the nutrient liquid storage 110 can be exposed to the outside through the separate opening.

The nutrient liquid supply 120 can be connected to the nutrient liquid storage 110 so that the nutrient liquid stored in the nutrient liquid storage 110 can be supplied to the cultivator 30 through the nutrient liquid supply 120. The nutrient liquid supply 120 can include a supply part channel 122 and a nutrient liquid discharger 124.

The supply part channel 122 can be connected to the nutrient liquid storage 110 so that the nutrient liquid discharged from the nutrient liquid storage 110 can flow through the supply part channel 122. When the nutrient liquid storage 110 is disposed at a lower level than that of the bed 20 on which the cultivator 30 is seated, a nutrient liquid pump for flowing the nutrient liquid can be provided on the supply part channel 122.

The supply part channel 122 can extend from the nutrient liquid storage 110 toward the bed 20. The nutrient liquid discharger 124 can be disposed in the supply part channel 122 to discharge the nutrient liquid flowing through the supply part channel 122 to the cultivator 30.

The nutrient liquid discharger 124 can be configured to supply the nutrient liquid directly onto the cultivator 30 or to the bed 20. The bed 20 can include a nutrient liquid receiver to which the nutrient liquid discharged from the nutrient liquid discharger 124 is supplied when the nutrient liquid supply 120 supplies the nutrient liquid to the bed 20. The bed can include a bed channel extending from the nutrient liquid receiver toward the cultivator 30 in which the nutrient liquid from the nutrient liquid receiver can flow into the cultivator 30.

The cultivator 30 can have a nutrient liquid inflow hole defined in a bottom thereof through which the nutrient liquid present in the bed 20 can inflow when the nutrient liquid discharger 124 discharges the nutrient liquid into the nutrient liquid receiver of the bed 20.

The bed channel can be defined in a top face or the inside of the bed 20, and can extend from the nutrient liquid receiver towards the receiving portion on which the cultivator 30 is seated. The nutrient liquid supplied through the nutrient liquid receiver can flow onto a bottom face of the receiving portion. The nutrient liquid in the receiving portion can be supplied through the nutrient liquid inflow hole into the inside of the cultivator while the cultivator 30 is being seated on the receiving portion.

When the cultivator 30 contains the cultivation medium, the cultivation medium can be formed in a columnar shape and can be supported on the bottom face of the cultivation vessel 32. The nutrient liquid supplied into the cultivation vessel 32 through the nutrient liquid inflow hole can be absorbed into a lower portion of the cultivation medium and can be delivered to the plant.

That is, in some implementations, the nutrient liquid supply 120 supplies the nutrient liquid to the nutrient liquid receiver of the bed 20 while the liquid flows through the nutrient liquid storage 110, the supply part channel 122, and the nutrient liquid discharger 124 in this order. The nutrient liquid in the nutrient liquid receiver can be supplied to the receiving portion through the bed channel of the bed 20. The nutrient liquid in the receiving portion can inflow through the nutrient liquid inflow hole into the cultivator 30 to supply the liquid to the cultivation medium or the plant.

FIG. 6 shows the nutrient liquid supply 120 in which the nutrient liquid discharger 124 discharges the nutrient liquid to the nutrient liquid receiver defined in the bed 20.

In some examples, the nutrient liquid supply 120 can further include a collection channel 126. The collection channel 126 can be configured to connect the bed 20 and the nutrient liquid storage 110 to each other. That is, the bed 20 can be constructed such that after the supply part of the nutrient liquid is finished, a portion of the nutrient liquid remaining in the receiving portion flows through the collection channel 126 and is collected to the nutrient liquid storage 110.

The collection channel 126 can be constructed to be opened and closed via a valve, etc. A controller 300 to be described later can be connected to the valve and configured to control whether or not to collect the nutrient liquid from the receiving portion. FIG. 6 shows the collection channel 126 extending from the bed 20 towards the nutrient liquid storage 110. For example, the controller 300 may include an electric circuit, an electronic controller, a processor, or the like. In some cases, the controller 300 may be provided separately from the cabinet 10.

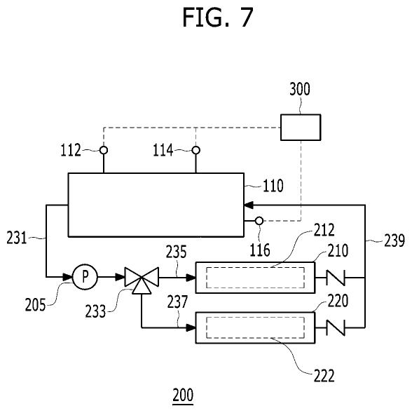

In some examples, the plant cultivation apparatus 1 can include a nutrient liquid circulator 200 for managing the nutrient liquid of the nutrient liquid storage 110. FIG. 7 is a conceptual diagram showing the nutrient liquid circulator 200.

As described above, the plant cultivation apparatus 1 can include the cabinet 10 and the nutrient liquid supply 100. The cabinet 10 can be constructed so that the cultivator 30 in which the at least portion of the plant is received is placed therein.

The nutrient liquid supply 100 can include the nutrient liquid storage 110 in which the nutrient liquid to be supplied to the cultivator 30 is stored and the nutrient liquid supply 120 connected to the nutrient liquid storage 110 to supply the nutrient liquid in the nutrient liquid storage 110 to the cultivator 30.

In some examples, the nutrient liquid circulator 200 includes a first member 210 to increase the pH of the nutrient liquid and the second member 220 to decrease the pH of the nutrient liquid. The nutrient liquid circulator 200 can be configured such that the nutrient liquid supplied from the nutrient liquid storage 110 can be re-supplied to the nutrient liquid storage 110 via one of the first member 210 and the second member 220.

The pH of the nutrient liquid stored in the nutrient liquid storage 110 can vary or impurities can be produced therein due to long-term storage thereof. As described above, the pH of the nutrient liquid in the nutrient liquid storage 110 can vary or the impurities can be produced due to other components in a process of the collection from the cultivator 30.

In some implementations, the apparatus can provide a high-quality nutrient liquid to the plant while effectively managing the nutrient liquid in the nutrient liquid storage 110 through the nutrient liquid circulator 200.

The nutrient liquid circulator 200 can be disposed in the machine room 50 provided in the cabinet 10, etc. and can be connected to the nutrient liquid storage 110 of the nutrient liquid supply 100. The nutrient liquid circulator 200 can include the first member 210 and the second member 220.

The nutrient liquid circulator 200 can be configured such that the nutrient liquid supplied from the nutrient liquid supply 100 can flow through the nutrient liquid circulator 200 and then can be fed back to the nutrient liquid supply 100. That is, the nutrient liquid from the nutrient liquid supply 100 can be circulated through the nutrient liquid circulator 200.

The first member 210 can be configured to increase the pH of the nutrient liquid flowing through the first member 210. For example, the first member 210 can contain a basic substance for increasing pH or contain the activated carbon. The basic substance can have a pH greater than a neutral pH (e.g., 7). For instance, pure water can have the neutral pH.

When the first member 210 contains an embedded consumable material, the first member 210 can be configured to be replaceable. For example, the first member 210 can include activated carbon. The activated carbon can be replaceable.

In some examples, the second member 220 can be configured to reduce the pH of the nutrient liquid flowing through the second member 220. For example, the second member 220 can include an acidic substance that reduces pH or can produce an acidic substance using an electric current or the like. The second member 220 can employ electrolysis to decompose water using electric current or the like. The acidic substance can have a pH less than a neutral pH (e.g., 7).

The nutrient liquid circulator 200 can be configured such that the nutrient liquid supplied from the nutrient liquid storage 110 flows through one of the first member 210 and the second member 220. For example, the nutrient liquid circulator 200 can be configured such that the nutrient liquid supplied from the nutrient liquid storage 110 flows through only one of the first member 210 and the second member 220, or sequentially flows through the first member 210 and the second member 220.

As described above, the pH of the nutrient liquid of the nutrient liquid storage 110 can vary due to degradation for the long-term storage or because the liquid can be mixed with other substances in the process of being collected through the bed 20 and the cultivator 30. The nutrient liquid with the pH value out of a certain range may interfere with the plant growth or cause abnormal condition.

The present disclosure describes the nutrient liquid circulator 200 that can manage the pH of the nutrient liquid in the plant cultivation apparatus 1, thereby effectively managing the nutrient liquid stored in the nutrient liquid storage 110 to supply the high-quality nutrient liquid to the plant for a long time. The nutrient liquid circulator 200 may be a fluidic system including various components such as pumps, pipes, tubes, valves, channels, etc.

FIG. 7 is a conceptual diagram showing an example of a nutrient liquid supply and a nutrient liquid circulator in the plant cultivation apparatus. In some examples, as shown in FIG. 7, in the plant cultivation apparatus 1, the nutrient liquid circulator 200 can further include the storage channel 231, the valve 233, a first connective channel 235 and a second connective channel 237.

The storage channel 231 can extend from the nutrient liquid storage 110, the valve 233 can be disposed on the storage channel 231, the first connective channel 235 can connect the valve 233 and the first member 210 to each other, and the second connective channel 237 can connect the valve 233 and the second member 220 to each other.

In some examples, the plant cultivation apparatus 1 can further include the controller 300. The controller 300 can be configured to control the valve 233 to cause flow of the nutrient liquid supplied through the storage channel 231 into one of the first connective channel 235 and the second connective channel 237.

The storage channel 231 can extend from the nutrient liquid storage 110 and can be provided in a form of a pipe or the like so that the nutrient liquid stored in the nutrient liquid storage 110 can flow therein and therethrough. The valve 233 can be disposed on the storage channel 231 to control the nutrient liquid flow in the storage channel 231.

Each of the first connective channel 235 and the second connective channel 237 can be implemented as a pipe and can extend from the valve 233 and can be connected to each of the first member 210 and the second member 220. That is, the first connective channel 235 can connect the valve 233 and the first member 210 to each other, and the second connective channel 237 can connect the valve 233 and the second member 220 to each other.

Accordingly, the nutrient liquid flowing along the storage channel 231 can flow through the valve 233 and then through the first connective channel 235 or the second connective channel 237. That is, the valve 233 can be controlled so that the nutrient liquid flows into one of the first connective channel 235 and the second connective channel 237.

The controller 300 can be placed in various locations inside the cabinet 10, such as in the machine room 50. The controller 300 can be connected to the valve 233 and configured to control the valve 233.

In some implementations, the controller 300 controls the valve 233 so that the nutrient liquid of the nutrient liquid storage 110 selectively flows through one of the first connective channel 235 and the second connective channel 237, and thus flow through one of the first member 210 and the second member 220, thereby increasing or decreasing the pH of the nutrient liquid stored in the nutrient liquid storage 110. In this way, the nutrient liquid with an appropriate pH value can be fed to the plant.

In some examples, the apparatus can further include a pH measuring device 112. The pH measuring device 112 can be configured to measure the pH of the nutrient liquid stored in the nutrient liquid storage 110. The pH measuring device 112 can be implemented in various ways. For example, the pH measuring device 112 can include a pH sensor, a pH meter, etc. that can measure the pH in a chemical method, an electrical method, or an electrochemical method. The pH measuring device 112 can be provided in various locations such as the nutrient liquid storage 110, the nutrient liquid supply 120, the bed 20, and the nutrient liquid circulator 200 to measure the pH of the nutrient liquid.

The controller 300 can be signally connected to the pH measuring device 112. The pH measuring device 112 can measure the pH of the nutrient liquid and transmit the pH measurement value to the controller 300. The controller 300 can control the nutrient liquid circulator 200 using the measurement value received from the pH measuring device 112.

For example, the nutrient liquid circulator 200 can include a management pump 205 for circulating the nutrient liquid in the nutrient liquid circulator 200, etc. When the measurement value of the pH measuring device 112 is out of a certain range, the controller 300 can be configured to operate the management pump 205 to operate the nutrient liquid circulator 200 and control the valve 233 to selectively use the first member 210 and the second member 220.

In some implementations, a preset reference pH range SP can be pre-stored to the controller 300 or the pH measuring device 112. The reference pH range SP means a pH range of the nutrient liquid for healthy plant growth without disturbing the plant growth. The reference pH range SP can be determined in various ways as needed.

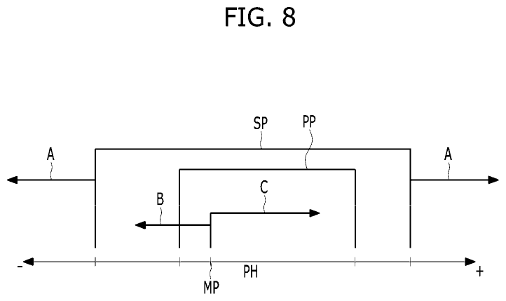

FIG. 8 is a diagram showing PH change in nutrient liquid in a plant cultivation apparatus. FIG. 8 shows the reference pH range SP as set.

The controller 300 can be configured to operate the nutrient liquid circulator 200 at all times. Alternatively, when the measured value of the pH measuring device 112 is out of the preset reference pH range SP, the controller 300 can be configured to operate the nutrient liquid circulator 200 such that a pH management mode can be performed.

That is, the controller 300 can control the nutrient liquid circulator 200 to perform the pH management mode in which when the measurement value of the pH measuring device 112 is equal to or lower than the preset reference pH range SP, the nutrient liquid supplied from the nutrient liquid storage 110 flows through the first member 210, while when the measurement value of the pH measuring device 112 is greater than or equal to the reference pH range SP, the nutrient liquid supplied from the nutrient liquid storage 110 flows through the second member 220.

Specifically, the controller 300 can control the nutrient liquid circulator 200 such that when the measurement value of the pH measuring device 112 is equal to or lower than the preset reference pH range SP, that is, is equal to or lower than a lower limit of the reference pH range SP, the nutrient liquid from the nutrient liquid storage 110 flows through the first member 210.

For example, the controller 300 can control the valve 233 of the nutrient liquid circulator 200 so that the nutrient liquid is supplied to the first member 210 through the first connective channel 235. The nutrient liquid flowing through the first member 210 can have an increased pH value depending on the characteristics of the first member 210.

In some examples, the controller 300 can control the nutrient liquid circulator 200 such that when the measurement value of the pH measuring device 112 is above the preset reference pH range SP, that is, when the measurement value of the pH measuring device 112 is above an upper limit of the reference pH range SP, the nutrient liquid from the nutrient liquid storage 110 flows through the second member 220.

For example, the controller 300 can control the valve 233 of the nutrient liquid circulator 200 so that the nutrient liquid is supplied to the second member 220 through the second connective channel 237. The nutrient liquid flowing through the second member 220 can have a reduced pH value depending on the characteristics of the second member 220.

FIG. 7 shows a re-supply channel 239 extending from the first member 210 and the second member 220 towards the nutrient liquid storage 110. That is, the nutrient liquid circulator 200 can further include the re-supply channel 239 connecting the first member 210 and the second member 220 to the nutrient liquid storage 110. The nutrient liquid flowing through the first member 210 and the second member 220 can be returned to the nutrient liquid storage 110 through the re-supply channel 239.

In some implementations, the apparatus can identify the pH value of the nutrient liquid of the nutrient liquid storage 110 through the pH measuring device 112. When the measurement value of the pH measuring device 112 is equal to or lower than the reference pH range SP which can be determined in various ways for healthy plant growth, the controller can increase the pH using the first member 210. When the measurement value of the pH measuring device 112 is greater than the reference pH range SP, the controller can reduce the pH using the second member 220. Thus, the management of the nutrient liquid to be fed to the plant can be performed effectively.

In some implementations, the controller 300 can control the nutrient liquid circulator 200 so that the measurement value of the pH measuring device 112 falls within a preset adequate pH range PP within the reference pH range SP in the pH management mode. For instance, the preset adequate pH range PP can be a threshold range to trigger the controller to control predetermined operations of the nutrient liquid circulator 200.

The adequate pH range PP can be pre-stored in the controller 300, and can be determined in various ranges according to various implementations. The adequate pH range PP can be set within a range within the reference pH range SP.

That is, a lower limit of the adequate pH range PP can be a value greater than or equal to the lower limit of the reference pH range SP, while a upper limit of the adequate pH range PP can have a value lower than or equal to the upper limit of the reference pH range SP. Further, the lower limit of the adequate pH range PP can be a value exceeding the lower limit of the reference pH range SP, while the upper limit of the adequate pH range PP can be a value lower than the upper limit of the reference pH range SP.

FIG. 8 shows an adequate pH range PP set within the reference pH range SP.

When the pH value of the nutrient liquid is out of the reference pH range SP for the healthy plant growth, the controller 300 operates the nutrient liquid circulator 200 to adjust the pH value of the nutrient liquid to be within the reference pH range SP. The controller 300 can determine an end time of the pH management mode using the measurement value of the pH measuring device 112 or an operating time duration of the nutrient liquid circulator 200.

However, when the operating of the nutrient liquid circulator 200 because the pH value of the nutrient liquid is out of the reference pH range SP results in a situation in which the adjusted pH value of the nutrient liquid falls within the reference pH range SP but has a slight difference from the lower limit or the upper limit of the reference pH range SP, the pH value of the nutrient liquid is more likely to deviate from the reference pH range SP for a relatively short period of time. Thus, the efficiency of the nutrient liquid management is lowered.

Therefore, in some implementations, the controller manages the nutrient liquid of the nutrient liquid storage 110 to be within the reference pH range SP such that when the measurement value of the pH measuring device 112 is out of the reference pH range SP, the controller 300 performs the pH management mode to adjust the pH of the nutrient liquid so that the measurement value of the pH measuring device 112 has a value within the adequate pH range PP set within the reference pH range SP. This can effectively improve the pH management efficiency of the nutrient liquid through nutrient liquid circulator 200.

For example, when the reference pH range SP is set in a range of 4 to 8, the adequate pH range PP can be set in a range of 5 to 7. However, the present disclosure is not limited thereto. The reference pH range SP and the adequate pH range PP can be set variously as needed.

With reference to FIG. 8, the pH management mode based on the pH value of the nutrient liquid will be described as follows.

FIG. 8 shows the reference pH range SP and other abnormal pH regions A. When the measurement value of the pH measuring device 112 is out of the reference pH range SP and is equal to the abnormal pH region A, the controller 300 can control the nutrient liquid circulator 200 to perform the pH management mode.

When the pH management mode is performed, the pH value of the nutrient liquid corresponding to the abnormal pH region A can be gradually adjusted into the reference pH range SP. In this connection, the controller 300 can perform the pH management mode until the pH value of the nutrient liquid, that is, the measurement value of the pH measuring device 112 goes beyond the reference pH range SP and falls into the adequate pH range PP.

When the pH value of the nutrient liquid is within the adequate pH range PP, the controller 300 can terminate the pH management mode. The pH value of the nutrient liquid falling into the adequate pH range PP can maintain a value within the reference pH range SP for a predetermined period of time while having a difference from a critical value of the reference pH range SP.

In some implementations, when the execution duration of the pH management mode is greater than or equal to a preset pH management allowed time duration, the measurement value of the pH measuring device 112 does not fall within the adequate pH range PP, the controller 300 can be configured to transmit a check signal to check the nutrient liquid circulator 200 to the user.

As described above, in some implementations, the controller 300 operates the nutrient liquid circulator 200 to perform the pH management mode when the measurement value of the pH measuring device 112 is out of the reference pH range SP.

However, even when the execution duration of the pH management mode is above a certain amount, and when the measurement value of the pH measuring device 112 still does not have a value within the adequate pH range PP, the controller can determine that the pH management ability of the first member 210 or the second member 220 is significantly reduced or an abnormal state of the pH measuring device 112 occurs.

Further, when the pH management mode has operated for a too large duration, a state of the nutrient liquid can change unfavorably to the plant growth regardless of the pH control. For example, when the first member 210 includes an activated carbon module 212 that uses the activated carbon, and as the operation time duration of the first member 210 is larger, an amount of ions in the nutrient liquid can be reduced due to the activated carbon. This can interfere with plant growth.

Further, when the second member 220 includes an electrolysis device 222 that uses electrolysis, and as the operation time duration of the second member 220 is larger, more various substances can be precipitated on electrodes of the electrolysis device 222. This can reduce the electrolysis ability of the electrolysis device 222 and can shorten the lifespan of the second member 220.

Accordingly, in some implementations, an appropriate time duration for which the measurement value of the pH measuring device 112 falls into the adequate pH range PP through the nutrient liquid circulator 200 can be preset as the pH management allowed time duration. Even when the execution duration of the pH management mode exceeds the pH management allowed time duration, but when the pH value of the nutrient liquid does not fall within the adequate pH range PP, the controller 300 can be configured to transmit the check signal for checking the nutrient liquid circulator 200 to the user.

The pH management allowed time duration can be determined as various values based on theoretical grounds and statistical results. Further, the check signal for checking the nutrient liquid circulator 200 can be sent to the user in a variety of ways.

For example, the plant cultivation apparatus 1 can include a display device for providing visual information to the user. The controller 300 can be connected to the display device and transmit the check signal for checking the nutrient liquid circulator 200 to the user through the display device in a visual way.

Further, the cabinet 10 can receive therein a speaker to provide audible information to the user. The controller 300 can transmit the check signal for checking the nutrient liquid circulator 200 in an audible way to the user through the speaker.

Further, as described above, the light irradiation unit for providing light to the cultivator 30 or the plant can be disposed inside the cabinet 10. The controller 300 can by control the light emitter to provide a light pattern that the user can recognize, thereby transmitting the check signal for checking the nutrient liquid circulator 200 to the user in an optical manner.

The user can perform exchange or check of the first member 210 and the second member 220 based on the check signal for checking the nutrient liquid circulator 200, and can check the inside of the nutrient liquid storage 110 or the pH measuring device 112.

In some cases, the first member 210 and the second member 220 can be periodically checked or replaced to adjust the pH of the nutrient liquid. In some implementations, the controller 300 can transmit the check signal for checking the nutrient liquid circulator 200 to the user based on the pH management result of the nutrient liquid using the nutrient liquid circulator 200, such that the effective maintenance of the nutrient liquid circulator 200 can be achieved.

In some implementations, the controller 300 can control the nutrient liquid circulator 200 such that a total operation time duration of one of the first member 210 and the second member 220 is smaller than or equal to a preset allowed operation time duration within a preset unit time duration.

That is, the controller 300 can control the nutrient liquid circulator 200 to limit the total operation duration of the first member 210 or the second member 220 from exceeding the allowed operation time duration.

Specifically, as described above, the excessive use of the first member 210 and the second member 220 to manage the pH of the nutrient liquid can worsen the state of the nutrient liquid independently of the pH value of the nutrient liquid or can deteriorate the performance of the first member 210 and the second member 220.

Accordingly, in some implementations, the controller 300 can control the nutrient liquid circulator 200 so that the total operation time duration of each of the first member 210 and the second member 220 does not exceed the allowed operation time duration within the preset unit time duration.

The unit time duration and the allowed operation time duration can be determined in various ways. The allowed operation time duration can be set to be smaller than the unit time duration. For example, when the unit time duration is set to one day, the allowed operation time duration can be set to a time duration smaller than 24 hours. When the unit time duration is set to one hour, the allowed operation time duration can be set to a time duration smaller than 60 minutes.

There can be various ways in which the controller 300 controls the nutrient liquid circulator 200 so that the total operation time duration of each of the first member 210 and the second member 220 is smaller than or equal to the allowed operation time duration.

For example, when the total operation time duration of the first member 210 exceeds the allowed operation time duration within the unit time duration, the controller 300 disables the pH management mode using the first member 210 and then, after the unit time duration has elapsed, and can perform the pH management mode using the first member 210.

Further, when the total operation time duration of the first member 210 exceeds the allowed operation time duration, the controller 300 disables the pH management mode using the first member 210 and can inform the user of the situation in which the allowed operation time duration exceeds the allowed operation time duration in a visual or audible manner.

In some implementations, the allowed operation time duration per the unit time duration of each of the first member 210 and the second member 220 can be preset, thereby managing the pH of the nutrient liquid, and at the same time, effectively suppressing occurrence of adverse phenomenon according to the pH control.

In an embodiment of the present disclosure, the apparatus further includes a remaining amount measuring device 116 that is configured to measure a remaining amount of the nutrient liquid stored in the nutrient liquid storage 110. The controller 300 can be configured to correct the allowed operation time duration based on a measurement value of the remaining amount measuring device 116.

The remaining amount measuring device 116 can be disposed in the nutrient liquid storage 110 to measure the remaining amount of the nutrient liquid stored in the nutrient liquid storage 110, and can be provided in various forms, such as an electrode sensor.

In some implementations, as the amount of the nutrient liquid stored in nutrient liquid storage 110 increases, the execution duration of the pH management mode can be increased to control the pH of the nutrient liquid. Deterioration of the state of the nutrient liquid or the deterioration of the performance of the first member 210 and the second member 220 as the operation time duration of each of the first member 210 and the second member 220 increases can be reduced.

That is, in some implementations, the controller 300 increases the allowed operation time duration as the remaining amount of the nutrient liquid in the nutrient liquid storage 110 increases, thereby flexibly operating the nutrient liquid circulator 200 based on the remaining amount of the nutrient liquid and thus executing the effective nutrient liquid management.

In some implementations, the first member 210 can be configured to increase the pH of the nutrient liquid while reducing turbidity thereof by removing impurities from the nutrient liquid.

That is, the first member 210 can be configured to reduce the turbidity of the nutrient liquid by removing impurities such as foreign substances contained in the nutrient liquid flowing through the first member 210. Accordingly, the nutrient liquid circulator 200 can increase the pH of the nutrient liquid or improve the turbidity of the nutrient liquid flowing through the first member 210.

In some implementations, the first member 210 can be configured such that the nutrient liquid supplied from the nutrient liquid storage 110 flows through the activated carbon to remove the impurities therefrom and increase the pH thereof.

That is, the first member 210 can include the activated carbon module 212 including activated carbon. As the nutrient liquid in the nutrient liquid storage 110 flows through the activated carbon module 212, the pH thereof is increased and impurities are removed therefrom, such that the turbidity can be improved.

When using the activated carbon, and as the use period of the activated carbon increases, the amount of the activated carbon can decrease, or the ability to remove impurities or increase the pH by the activated carbon can decrease. Thus, the activated carbon module 212 can be replaced.

In some implementations, the second member 220 can be configured to apply electric current to the nutrient liquid supplied from the nutrient liquid storage 110 to sterilize the nutrient liquid and reduce the pH thereof.

That is, the second member 220 can generate the sterilization effect of the nutrient liquid by applying the electric current to the nutrient liquid flowing through the second member 220. This can decompose the water via the application of the electric current to generate acidic substances such as hypochlorous acid to reduce the pH value of the nutrient liquid.

For example, the second member 220 can include the electrolysis device 222 capable of applying the current into the nutrient liquid. The electrolysis device 222 can include an electrode in contact with the nutrient liquid. Thus, an electrolytic effect can be generated by applying a voltage to the electrode to apply the electric current to the nutrient liquid.

In some examples, the plant cultivation apparatus 1 can further include a turbidity measuring device 114 provided to measure the turbidity of the nutrient liquid stored in the nutrient liquid storage 110.

When the measurement value of the turbidity measuring device 114 is greater than or equal to a preset reference turbidity, the controller 300 can perform a turbidity management mode to control the nutrient liquid circulator 200 so that the nutrient liquid supplied from the nutrient liquid storage 110 flows through the first member 210.

The turbidity measuring device 114 can be provided in the nutrient liquid storage 110, and can be configure top measure the turbidity of the nutrient liquid stored in the nutrient liquid storage 110. The turbidity measuring device 114 can be embodied in various types. For example, the turbidity measuring device 114 detects an amount of light travelling through the nutrient liquid, or images a surface of the nutrient liquid and perform image analysis to measure the turbidity or measures current or resistance value of the electrical current flowing through the nutrient liquid. That is, the turbidity measuring device 114 can include a light sensor or a camera.

The controller 300 can be signally connected to the turbidity measuring device 114 and can receive a measurement value of the turbidity measuring device 114. Further, a reference turbidity is preset and pre-stored in the controller 300. When the measurement value of the turbidity measuring device 114 is greater than or equal to the reference turbidity, the turbidity management mode can be performed.

The reference turbidity can be set to various values based on theoretical grounds and statistical results. In the turbidity management mode, the controller 300 can control the nutrient liquid circulator 200 to remove impurities from the liquid as the nutrient liquid from the nutrient liquid storage 110 flows through the first member 210.

In some implementations, in an event in which the measurement value of the turbidity measuring device 114 is greater than or equal to the reference turbidity in a state in which an execution duration of the turbidity management mode is greater than or equal to a preset turbidity management allowed time duration, the controller 300 can inform the user of the event by transmitting a nutrient liquid check signal to the user.

In some implementations, even though the execution duration of the turbidity management mode is above a certain amount, but when reduction in the turbidity is not effectively achieved, the controller can determine that impurity removal performance of the first member 210 for reducing the turbidity can be in a deteriorated state or the nutrient liquid itself can be in an abnormal state.

The abnormal state of the nutrient liquid can represent that the impurities in the nutrient liquid are excessive, the type of impurities is unusual, or a problem occurs inside the nutrient liquid storage 110 or abnormality in the turbidity measuring device 114 occurs.

Accordingly, in some implementations, the reference turbidity and the turbidity management allowed time duration can be preset and pre-stored in the controller. Thus, the controller 300 can transmit the nutrient liquid check signal based on the execution result of the turbidity management mode.

The nutrient liquid check signal can be transmitted to the user in various ways, for example, through the display device, the speaker, the light irradiator, etc. as the check signal for checking the nutrient liquid circulator 200 as described above can be. The turbidity management allowed time duration can be preset and pre-stored in the controller 300, and can be determined in various ways based on theoretical basis and statistical results.

In some implementations, when the measurement value of the turbidity measuring device 114 is equal to or greater than the reference turbidity and the measurement value of the pH measuring device 112 is lower than or equal to a preset turbidity management pH value MP, the controller 300 can control the nutrient liquid circulator 200 to perform the turbidity management mode.

As described above, in some implementations, the first member 210 can be configured to increase the pH of the nutrient liquid and to filter the impurities of the nutrient liquid at the same time. That is, when the turbidity management mode is performed, the nutrient liquid flows through the first member 210 such that the pH thereof can be increased.

Therefore, when the turbidity management mode is performed under an event in which the measurement value of the turbidity measuring device 114 is greater than or equal to the reference turbidity, the pH value of the nutrient liquid becomes excessively higher and can deviate from the reference pH range SP.

Accordingly, in some implementations, the turbidity management pH value MP as a reference for performing the turbidity management mode can be present and pre-stored in the controller 300. The turbidity management mode can be performed when the measurement value of the turbidity measuring device 114 is equal to or greater than the reference turbidity and the measurement value of the pH measuring device 112 is lower than or equal to the turbidity management pH value MP.

Based on the characteristic of the first member 210 to increase the pH value of the nutrient liquid, the turbidity management pH value MP can have a value equal to or lower than a middle value of the reference pH range SP or adequate pH range PP.

In some implementations, when the measurement value of the turbidity measuring device 114 is equal to or greater than the reference turbidity, and the measurement value of the pH measuring device 112 exceeds the turbidity management pH value MP, the controller 300 can control the nutrient liquid circulator 200 to perform a pH preparation mode in which the nutrient liquid supplied from the nutrient liquid storage 110 flows through the second member 220.

Further, after the controller 300 performs the pH preparation mode such that the measurement value of the pH measuring device 112 is lower than or equal to the turbidity management pH value MP, the controller 300 can perform the turbidity management mode.

Specifically, when the measurement value of the turbidity measuring device 114 is greater than or equal to the reference turbidity and the measurement value of the pH measuring device 112 exceeds the turbidity management pH value MP, the controller 300 can perform the pH preparation mode for lowering the pH value of the nutrient liquid.

Unlike the pH management mode, the pH preparation mode can adjust the pH value of the nutrient liquid even when the pH value of the nutrient liquid is within the reference pH range SP or the adequate pH range PP.

With reference to FIG. 8, description of the pH management mode and the pH preparation mode for the turbidity management mode will be made as follows.

As described above, when the pH value of the nutrient liquid is equal to the abnormal pH region A, the pH management mode can be executed to adjust the pH value of the nutrient liquid to a value within the adequate pH range PP. In some examples, when the turbidity management pH value MP exceeds the turbidity management pH value MP even when the pH value of the nutrient liquid is within the reference pH range SP or the adequate pH range PP, the pH preparation mode can be performed to adjust the pH value of the nutrient liquid to a value lower than or equal to the turbidity management pH value MP.

That is, the turbidity management mode can be configured as follows: when the pH value of the nutrient liquid is in a region C exceeding the turbidity management pH value, the turbidity management mode can be performed after the pH preparation mode has been executed; or when the pH value of the nutrient liquid is in a region B equal to or lower than the turbidity management pH value, the turbidity management mode can be performed without the pH preparation mode.

In some implementations, the apparatus can properly adjust the pH value of the nutrient liquid and remove the impurities of the nutrient liquid or perform sterilization using the first member 210 and the second member 220. Furthermore, ensuring that the pH value of the nutrient liquid is within the reference pH range SP or the adequate pH range PP even when the turbidity lowering process via the removal of impurities is performed can allow the nutrient liquid to be effectively managed and fed to the plant.

In some implementations, the turbidity management pH value MP can be set to have a value greater than or equal to the lower limit of the adequate pH range PP.

Specifically, as described above, in some implementations, the turbidity management mode can be conducted to increase the pH value of the nutrient liquid. Thus, the turbidity management pH value MP can have a value lower than or equal to a middle value of the reference pH range SP or the adequate pH range PP. As the turbidity management pH value MP is lower, this may not interfere with performance of the turbidity management mode.

In some examples, as described above, the pH management mode can be conducted to adjust the pH value of the nutrient liquid to a value within the adequate pH range PP. In this connection, there can be cases where when the turbidity management pH value MP has a value lower than the lower limit of the adequate pH range PP, the turbidity management mode may not be performed immediately even after the pH value of the nutrient liquid has been adequately adjusted via the pH management mode.

For example, when the turbidity management pH value MP has a value lower than the lower limit of the adequate pH range PP, a following situation may occur: when the pH value of the nutrient liquid is equal to a value equal to or lower than the reference pH range SP, the pH value of the nutrient liquid can be adjusted to a value within the adequate pH range PP via the pH management mode; however, although the pH value of the nutrient liquid has been adjusted to the adequate value via the pH management mode, the process of adjusting the pH for the turbidity management mode is performed again; thus, the meaning of the adequate pH range PP can be insignificant and thus, the pH management mode can be inefficient.

Accordingly, in some implementations, the turbidity management pH value MP can be set to be equal to or higher than the lower limit of the adequate pH range PP. Thus, the turbidity management mode can be performed on the nutrient liquid whose a pH value has been adjusted via the pH management mode without additional pH adjustment.

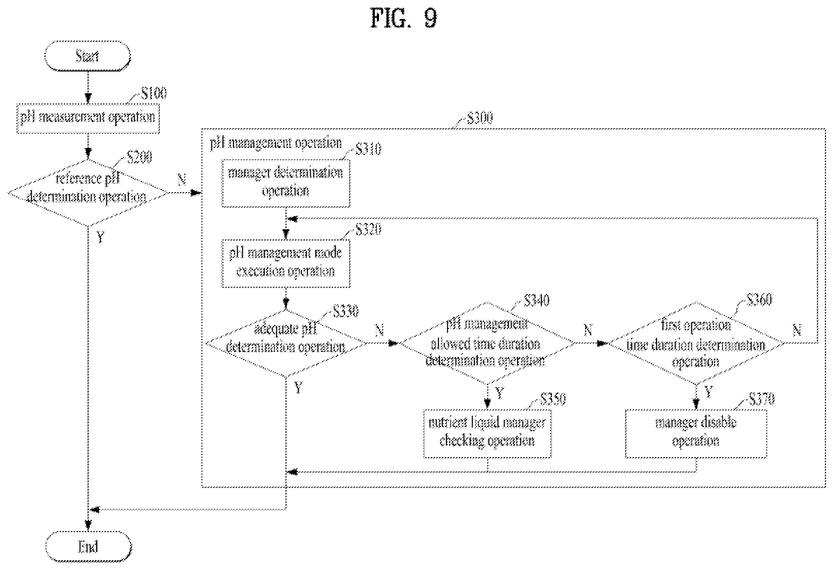

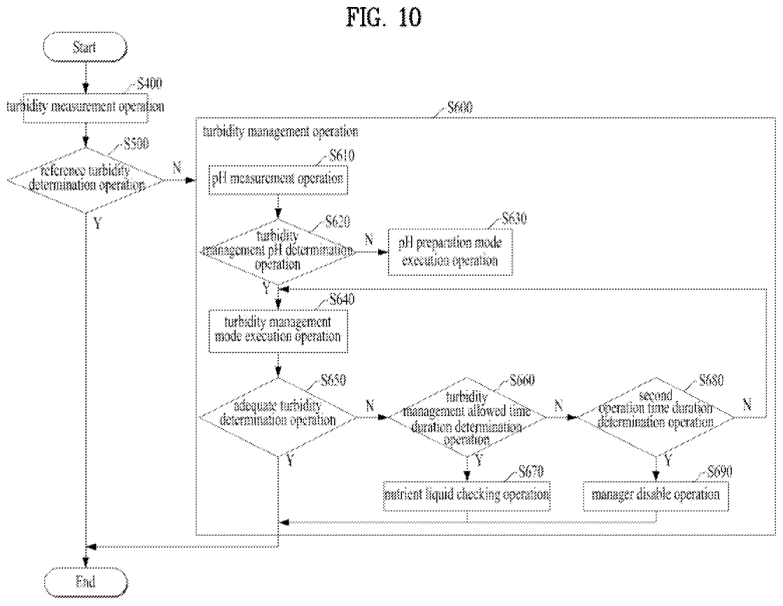

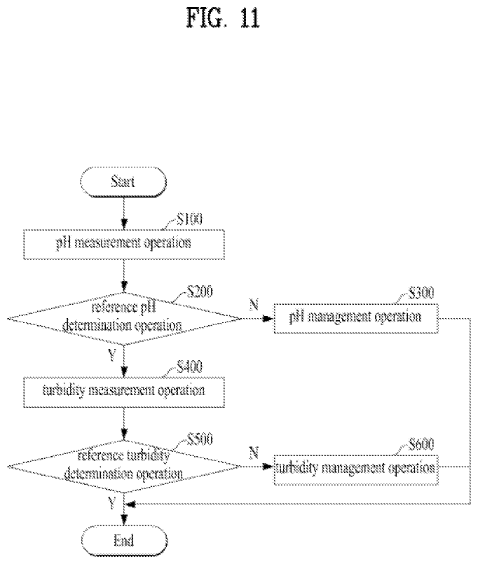

FIGS. 9 to 11 are examples of flowcharts showing a method for controlling the plant cultivation apparatus 1. FIG. 9 is a flow chart showing a pH management operation S300, FIG. 10 is a flow chart showing a turbidity management operation S600, FIG. 11 is a flowchart showing the pH management operation S300 and the turbidity management operation S600 together.

As shown in FIG. 9, the method for controlling the plant cultivation apparatus 1 includes a reference pH determination operation S200 and the pH management operation S300.

In the reference pH determination operation S200, the controller 300 determines whether the measurement value of the pH measuring device 112 to measure the pH of the nutrient liquid stored in the nutrient liquid storage 110 falls within the preset reference pH range SP.

When it is determined in the reference pH determination operation S200 that the measurement value of the pH measuring device 112 does not fall within the reference pH range SP, the controller 300 controls the nutrient liquid circulator 200 to perform the pH management mode to adjust the pH of the nutrient liquid stored in the nutrient liquid storage 110 in the pH management operation S300.

The method for controlling the plant cultivation apparatus 1 including the pH management operation S300 with reference to FIG. 9 is described as follows. Duplicate descriptions with those as previously described in the plant cultivation apparatus 1 will be omitted.

The control method can include a pH measurement operation S100. The pH measuring device 112 112 can measure the pH value of the nutrient liquid stored in the nutrient liquid storage 110 in the pH measurement operation S100.

The control method can include the reference pH determination operation. In the reference pH determination operation, the controller 300 can determine whether the measurement value of the pH measuring device 112 measured in the pH measurement operation S100 falls within the preset reference pH range SP pre-stored in the controller 300.

The control method can include the pH management operation S300. When it is determined in the reference pH determination operation that the measurement value of the pH measuring device 112 is out of the reference pH range SP, the controller 300 controls the nutrient liquid circulator 200 to adjust the pH value of the nutrient liquid in the pH management operation S300.

The pH management operation S300 can include a manager determination operation S310. In the manager determination operation S310, the manager for adjusting the pH value of the nutrient liquid in the pH management operation S300 can be determined.

For example, in the manager determination operation S310, the controller 300 determines the operation of the first member 210 to increase the pH value when the pH value of the nutrient liquid is equal to or lower than the reference pH range SP. In the manager determination operation S310, the controller 300 determines the operation of the second member 220 to reduce the pH value when the pH value is above the reference pH range SP.

The pH management operation S300 can include a pH management mode execution operation S320. In pH management mode execution operation S320, the controller 300 can perform the pH management mode. That is, the controller 300 can adjust the pH value of the nutrient liquid using one of the first member 210 and the second member 220 of the nutrient liquid circulator 200 as determined in the manager determination operation S310.

The pH management operation S300 can include an adequate pH determination operation S330. In adequate pH determination operation S330, the controller 300 can determine whether the pH value of the nutrient liquid as adjusted via the pH management mode execution operation S320 falls within the adequate pH range PP.

In some examples, the pH management operation S300 can include a pH management allowed time duration determination operation S340. When it is determined in the adequate pH determination operation S330 that the pH value of the nutrient liquid does not fall within the adequate pH range PP, the controller 300 can perform the pH management allowed time duration determination operation S340.

In the pH management allowed time duration determination operation S340, the controller 300 can determine whether a pH management mode duration of the pH management mode execution operation S320 exceeds the pH management allowed time duration.

In some examples, the pH management operation S300 can include a nutrient liquid circulator checking operation S350. When it is determined in the pH management allowed time duration determination operation S340 that the execution duration of the pH management mode execution operation S320 or the pH management mode exceeds the pH management allowed time duration, the controller 300 can perform the nutrient liquid circulator checking operation S350. In the nutrient liquid circulator checking operation S350, the controller 300 can transmit the check signal for checking the nutrient liquid circulator 200 to the user.

In some examples, when it is determined in the pH management allowed time duration determination operation S340 that the execution duration of the pH management mode execution operation S320 or the pH management mode is smaller than or equal to the pH management allowed time duration, the controller 300 can perform a first operation time duration determination operation S360.

In the first operation time duration determination operation S360, the controller 300 can determine whether a total operation time duration of the manager as determined via the manager determination operation S310 within the preset unit time duration exceeds the preset allowed operation time duration.

When it is determined in the first operation time duration determination operation S360 that the operation time duration exceeds the allowed operation time duration, the controller 300 can perform a manager disable operation S370.

In the manager disable operation In S370, the controller 300 can disable the operation of the nutrient liquid circulator 200. In this case, the controller 300 can transmit a signal indicating the disabled operation of the nutrient liquid circulator 200 to the user.

In some examples, when it is determined in the first operation time duration determination operation S360 that the allowed operation time duration is smaller than or equal to the operation time duration, the controller 300 can continuously perform the pH management mode execution operation S320.

In some implementations, an order in which the pH management allowed time duration determination operation S340 and the first operation time duration determination operation S360 are performed can vary. For example, unlike shown in FIG. 9, the first operation time duration determination operation S360 can be performed before the pH management allowed time duration determination operation S340.

In some examples, with reference to FIG. 10, the method for controlling the plant cultivation apparatus 1 including a turbidity management operation S600 will be described as follows.

Specifically, the method for controlling the plant cultivation apparatus 1 can include a turbidity measurement operation S400. In the turbidity measurement operation S400, the turbidity of the nutrient liquid stored in the nutrient liquid storage 110 can be measured by the turbidity measuring device 114.

After the turbidity measurement operation S400, the controller 300 can perform a reference turbidity determination operation S500. The reference turbidity determination operation S500 can be performed simultaneously with the turbidity measurement operation S400.

In the reference turbidity determination operation S500, the controller 300 can determine whether a measurement value of the turbidity measuring device 114 is greater than or equal to the preset reference turbidity.

When it is determined in the reference turbidity determination operation S500 that the measurement value of the turbidity measuring device 114 is equal to or greater than the reference turbidity, the controller 300 can perform the turbidity management operation S600. In turbidity management operation S600, the controller 300 can perform a pH measurement operation S610 for turbidity management.

In the pH measurement operation S610, the pH value of the nutrient liquid can be measured through the pH measuring device 112. After the pH measurement operation S610, the controller 300 can perform a turbidity management pH determination operation S620.

In the turbidity management pH determination operation S620, the controller 300 can determine whether the measurement value of the pH measuring device 112 is lower than or equal to the turbidity management pH value MP. When it is determined in the turbidity management pH determination operation S620 that the measurement value of the pH measuring device 112 exceeds the turbidity management pH value MP, the controller 300 can perform a pH preparation mode execution operation S630.

In the pH preparation mode execution operation S630, the controller 300 can perform the pH preparation mode. That is, the controller 300 can control the nutrient liquid circulator 200 to adjust the pH value of the nutrient liquid so that the pH value of the nutrient liquid is lower than or equal to the turbidity management pH value MP. After the pH preparation mode execution operation S630, the controller 300 can perform the turbidity management pH determination operation S620 again.

In some examples, when it is determined in the turbidity management pH determination operation S620 that the measurement value of the pH measuring device 112 is determined to be lower than or equal to the turbidity management pH value MP, the controller 300 can perform a turbidity management mode execution operation S640.

In the turbidity management mode execution operation S640, the controller 300 can perform the turbidity management mode. That is, the controller 300 can control the nutrient liquid circulator 200 so that the nutrient liquid flows through the first member 210 to reduce the turbidity.

After the turbidity management mode execution operation S640, the controller 300 can perform an adequate turbidity determination operation S650. In the adequate turbidity determination operation S650, the controller 300 can determine whether the measurement value of the turbidity measuring device 114 is lower than or equal to the adequate turbidity which has a value lower than the reference turbidity.

In some examples, when it is determined in the adequate turbidity determination operation S650 that the measurement value of the turbidity measuring device 114 exceeds the adequate turbidity, the controller 300 can perform a turbidity management allowed time duration determination operation S660.

In the turbidity management allowed time duration determination operation S660, the controller 300 can determine whether a turbidity management mode duration of the turbidity management mode execution operation S640 exceeds a turbidity management allowed time duration.

In some examples, the turbidity management operation S600 can include a nutrient liquid checking operation S670. When it is determined in the turbidity management allowed time duration determination operation S660 that the execution duration of the turbidity management mode execution operation S640 or the turbidity management mode exceeds the turbidity management allowed time duration, the controller 300 can perform a nutrient liquid checking operation S670. In the nutrient liquid checking operation S670, the controller 300 can transmit the nutrient liquid check signal to the user.

In some examples, when it is determined in the turbidity management allowed time duration determination operation S660 that the execution duration of the turbidity management mode execution operation S640 or the turbidity management mode is smaller than or equal to the turbidity management allowed time duration, the controller 300 can perform a second operation time duration determination operation S680.

In the second operation time duration determination operation S680, the controller 300 can determine whether a total operation time duration of the first member 210 for performing the turbidity management mode within the preset unit time duration exceeds the preset allowed operation time duration.

When it is determined in the second operation time duration determination operation S680 that the operation time duration exceeds the allowed operation time duration, the controller 300 can perform a manager disable operation S690.

In the manager disable operation S690, the controller 300 can disable the operation of the nutrient liquid circulator 200. In this case, the controller 300 can transmit a signal indicating the disabled operation of the nutrient liquid circulator 200 to the user.

In some examples, when it is determined in the second operation time duration determination operation S680 that the allowed operation time duration is lower than or equal to the operation time duration, the controller 300 can continuously perform the turbidity management mode execution operation S640.

In some implementations, an order in which the turbidity management allowed time duration determination operation S660 and the second operation time duration determination operation S680 are performed can vary. For example, unlike shown in FIG. 10, the second operation time duration determination operation S680 can be performed before the turbidity management allowed time duration determination operation S660.

In some examples, with reference to FIG. 11, the method for controlling the plant cultivation apparatus 1 including the pH management operation S300 and the turbidity management operation S600 together will be described as follows.

In some implementations, the controller 300 can perform the pH measurement operation S100 for measuring the pH value of the nutrient liquid and can perform the aforementioned reference pH determination operation S200.

When it is determined in the reference pH determination operation S200 that the measurement value of the pH measuring device 112 is out of the reference pH range SP, the controller 300 can perform the above-described pH management operation S300. When it is determined in the reference pH determination operation S200 that the measurement value of the pH measuring device 112 falls within the reference pH range SP, the controller 300 can perform the aforementioned reference turbidity determination operation S500.

When it is determined in the reference turbidity determination operation S500 that the measurement value of the turbidity measuring device 114 is equal to or greater than the reference turbidity, the controller 300 can perform the turbidity management operation S600 as described above.

Although the embodiments of the present disclosure have been described in more detail with reference to the accompanying drawings, the present disclosure is not necessarily limited to these embodiments. The present disclosure can be implemented in various modified manners within the scope not departing from the technical idea of the present disclosure. Accordingly, the embodiments disclosed in the present disclosure are not intended to limit the technical idea of the present disclosure, but to describe the present disclosure. The scope of the technical idea of the present disclosure is not limited by the embodiments. Therefore, it should be understood that the embodiments as described above are illustrative and non-limiting in all respects. The scope of protection of the present disclosure should be interpreted by the claims, and all technical ideas within the scope of the present disclosure should be interpreted as being included in the scope of the present disclosure.

What is claimed is:

1. A plant cultivation apparatus comprising:
a cabinet configured to accommodate a cultivator that is configured to accommodate at least a portion of a plant;
a storage configured to store nutrient liquid to be supplied to the cultivator;
a supply path connected to the storage and configured to supply the nutrient liquid from the storage to the cultivator; and
a nutrient liquid circulator comprising a first member configured to increase a pH of the nutrient liquid and a second member configured to decrease the pH of the nutrient liquid,
wherein the nutrient liquid circulator is configured to discharge the nutrient liquid from the storage and to circulate the nutrient liquid to the storage through at least one of the first member or the second member.

2. The plant cultivation apparatus of claim 1, wherein the nutrient liquid circulator further comprises:
a storage channel that extends from the storage;
a valve disposed at the storage channel;
a first connective channel that connects the valve to the first member; and
a second connective channel that connects the valve to the second member, and
wherein the plant cultivation apparatus further comprises a controller configured to control the valve to supply the nutrient liquid discharged from the storage channel to one of the first connective channel or the second connective channel.

3. The plant cultivation apparatus of claim 1, wherein the first member comprises a basic substance having a pH range greater than a neutral pH, and the second member comprises an acidic substance having a pH range less than the neutral pH.

4. The plant cultivation apparatus of claim 1, further comprising:
a pH sensor configured to measure the pH of the nutrient liquid stored in the storage; and
a controller configured to control the nutrient liquid circulator to perform a pH management mode in which the nutrient liquid circulator controls a path of the nutrient liquid to the first member or the second member based on a measurement value of the pH sensor.

5. The plant cultivation apparatus of claim 4, wherein the nutrient liquid circulator is configured to:
based on the measurement value of the pH sensor being less than or equal to a reference pH range, circulate the nutrient liquid to the storage through the first member; and
based on the measurement value of the pH sensor being greater than the reference pH range, circulate the nutrient liquid to the storage through the second member.

6. The plant cultivation apparatus of claim 5, wherein the controller is configured to control the nutrient liquid circulator to perform the pH management mode such that the measurement value of the pH sensor becomes within a threshold pH range that is preset within the reference pH range.

7. The plant cultivation apparatus of claim 6, wherein the controller is configured to transmit a check signal to a user for checking the nutrient liquid circulator based on the measurement value of the pH sensor remaining outside the threshold pH range for an execution duration of the pH management mode that is greater than or equal to a preset duration.

8. The plant cultivation apparatus of claim 5, wherein the controller is configured to control the nutrient liquid circulator to limit a total operation duration of each of the first member and the second member within a preset operation duration.

9. The plant cultivation apparatus of claim 8, further comprising a nutrient sensor configured to measure a remaining amount of the nutrient liquid stored in the storage,
wherein the controller is configured to change the preset operation duration based on a measurement value of the nutrient sensor.

10. The plant cultivation apparatus of claim 1, wherein the first member is configured to remove impurities from the nutrient liquid to thereby reduce a turbidity of the nutrient liquid, and
wherein the first member is configured to increase the pH of the nutrient liquid while removing the impurities from the nutrient liquid.

11. The plant cultivation apparatus of claim 10, wherein the first member comprises activated carbon, the first member being configured to, based on the nutrient liquid passing through the activated carbon, remove the impurities from the nutrient liquid and increase the pH of the nutrient liquid.

12. The plant cultivation apparatus of claim 1, wherein the second member is configured to apply an electrical current to the nutrient liquid discharged from the storage to thereby sterilize the nutrient liquid and reduce the pH of the nutrient liquid.

13. The plant cultivation apparatus of claim 10, further comprising:
a turbidity sensor configured to measure the turbidity of the nutrient liquid stored in the storage; and
a controller configured to, based on a measurement value of the turbidity sensor being greater than or equal to a reference turbidity, control the nutrient liquid circulator to perform a turbidity management mode to thereby circulate the nutrient liquid through the first member.

14. The plant cultivation apparatus of claim 13, wherein the controller is configured to transmit a check signal to a user for checking the nutrient liquid based on the measurement value of the turbidity sensor remaining greater than or equal to the reference turbidity for an execution duration of the turbidity management mode that is greater than or equal to a preset duration.

15. The plant cultivation apparatus of claim 13, further comprising a pH sensor configured to measure the pH of the nutrient liquid stored in the storage,
wherein the controller is configured to control the nutrient liquid circulator to perform the turbidity management mode based on the measurement value of the turbidity sensor being greater than or equal to the reference turbidity and a measurement value of the pH sensor being lower than or equal to a turbidity management pH value.

16. The plant cultivation apparatus of claim 15, wherein the controller is configured to:
based on the measurement value of the turbidity sensor being greater than or equal to the reference turbidity and the measurement value of the pH sensor exceeding the turbidity management pH value, control the nutrient liquid circulator to perform a pH preparation mode to thereby circulate the nutrient liquid to the storage through the second member; and
perform the turbidity management mode based on the measurement value of the pH sensor becoming less than or equal to the turbidity management pH value during performance of the pH preparation mode.

17. The plant cultivation apparatus of claim 16, wherein the controller is configured to, based on the measurement value of the pH sensor being outside a reference pH range, control the nutrient liquid circulator to perform a pH management mode such that the measurement value of the pH sensor becomes within a threshold pH range that is preset within the reference pH range, and
wherein the turbidity management pH value is greater than or equal to a lower limit of the threshold pH range.

18. A method for controlling a plant cultivation apparatus, the plant cultivation apparatus including a cabinet configured to accommodate a cultivator that is configured to accommodate at least a portion of a plant, a storage configured to store nutrient liquid to be supplied to the cultivator, a supply path connected to the storage and configured to supply the nutrient liquid from the storage to the cultivator, and a nutrient liquid circulator including a first member configured to increase a pH of the nutrient liquid and a second member configured to decrease the pH of the nutrient liquid, the nutrient liquid circulator being configured to discharge the nutrient liquid from the storage and to circulate the nutrient liquid to the storage through at least one of the first member or the second member, and a controller configured to control the nutrient liquid circulator, the method comprising:
measuring a pH of the nutrient liquid stored in the storage by a pH sensor;
determining whether a measurement value of the pH sensor is within a reference pH range; and
based on the measurement value of the pH sensor being outside the reference pH range, controlling the nutrient liquid circulator to perform a pH management mode to thereby adjust the pH of the nutrient liquid stored in the storage.

19. The method of claim 18, wherein controlling the nutrient liquid circulator comprises:
based on the measurement value of the pH sensor being less than or equal to the reference pH range, circulating the nutrient liquid to the storage through the first member; and
based on the measurement value of the pH sensor being greater than the reference pH range, circulating the nutrient liquid to the storage through the second member.

20. The method of claim 19, further comprising:
performing the pH management mode until the measurement value of the pH sensor comes in a threshold pH range that is preset within the reference pH range.
